(19) United States
(12) Patent Application Publication
(10) Pub. No.: US 2022/0258242 A1
(43) Pub. Date: Aug. 18, 2022

(54) ADDITIVE-FREE MANUFACTURING OF GEOMETRICALLY COMPLEX COMPONENTS FOR ELECTRICAL ENERGY STORAGE SYSTEMS

(71) Applicants: THE REGENTS OF THE UNIVERSITY OF CALIFORNIA, Oakland, CA (US); California Institute of Technology, Pasadena, CA (US)

(72) Inventors: Julie M. Schoenung, Oakland, CA (US); Katherine A. Acord, Oakland, CA (US); Baolong Zheng, Oakland, CA (US); Umberto Scipioni Bertoli, Oakland, CA (US); Andrew A. Shapiro, Pasadena, CA (US); Qian Nataly Chen, Pasadena, CA (US); William C. West, Pasadena, CA (US)

(73) Assignees: THE REGENTS OF THE UNIVERSITY OF CALIFORNIA, Oakland, CA (US); California Institute of Technology, Pasadena, CA (US)

(21) Appl. No.: 17/622,691

(22) PCT Filed: Apr. 24, 2020
(86) PCT No.: PCT/US2020/029966

§ 371 Date: Dec. 23, 2021

Related U.S. Application Data
(60) Provisional application No. 62/867,674, filed on Jun. 27, 2019.

(51) Int. Cl. B22F 10/28; B23K 26/352; B33Y 10/00; B33Y 80/00; H01M 4/04

(52) U.S. Cl. CPC B22F 10/28; B23K 26/352; B23K 2101/36; B33Y 80/00; H01M 4/0402; B33Y 10/00

(57) ABSTRACT

In some embodiments, high-energy additive manufacturing (HE-AM) (e.g., directed energy deposition, powder injection, powder bed fusion, electron beam melting, solid-state, and ultrasonic) is used to overcome constraints of comparative EES fabrication techniques to produce chemical additive-free electrodes with complex, highly versatile designs for next generation EES. An exemplary rapid fabrication technique provides an approach for improving electrochemical performance while increasing efficiency and sustainability, reducing time to market, and lowering production costs. With this exemplary technique, which utilizes computer models for location specific layer-by-layer fabrication of three-dimensional parts (e.g., versatile design), a high degree of control over processing conditions may be achieved to enhance both the design and performance of EES systems.

### RELATED APPLICATIONS

This application is a 371 National Stage Entry of International Application No. PCT/US2020/029966, filed Apr. 24, 2020, which claims the domestic benefit under Title 35 of the United States Code § 119(e) of U.S. Provisional Application No. 62/867,674, entitled “Additive-free Manufacturing of Geometrically Complex Electrode for Electrical Energy Storage Systems,” filed Jun. 27, 2019, each of which are hereby incorporated by reference in their entirety and for all purposes as if completely and fully set forth herein.

### STATEMENT REGARDING FEDERALLY-SPONSORED RESEARCH OR DEVELOPMENT

This invention was made with government support under Grant Number 1613317, awarded by the Jet Propulsion Laboratory (“JPL”). The government has certain rights in the invention.

### TECHNICAL FIELD

This disclosure relates to an improved approach for fabricating three-dimensional electrical energy storage components including but not limited to electrodes and solid electrolytes usable in electrical energy storage systems, and made from electrical energy storage materials (e.g., electrochemically active, electrically conductive, ionically conductive materials), without the use of binders or other chemical additives to improve electrochemical performance.

### BACKGROUND

Electrical energy storage (EES) systems provide energy on demand. Lithium ion batteries are one example of an EES system, widely used in commercial products, that are highly subject to consumer-based demands for longer battery life and faster charging. Battery life depends on the amount of charge held in a battery, which is related to the volume of electrochemically active material present in the battery and a chemical composition of battery components (e.g., electrodes, solid electrolytes). The rate of charging depends on the interfacial area between an electrode and an electrolyte and resistance to ion and electron transport, which can be improved by altering an EES architecture.

Fabrication techniques that aim to eliminate the inclusion of chemical additives or enhance design versatility are inefficient, unsustainable, time consuming, and expensive. Fabrication of chemical additive-free EES components with highly versatile designs remains desirable.

### SUMMARY

Achieving EES systems with high power density and high energy density is a long-standing goal within the energy community. In some embodiments, high-energy additive manufacturing (HE-AM) (e.g., directed energy deposition, powder injection, powder bed fusion, electron beam melting, solid-state, and ultrasonic) is used to overcome constraints of comparative EES systems fabrication techniques to produce chemical additive-free EES components (e.g., electrodes and solid electrolytes) with complex, highly versatile designs for next generation EES systems. An exemplary rapid fabrication technique provides an approach for improving EES performance while increasing efficiency and sustainability, reducing time to market, and lowering production costs. With this exemplary technique, which utilizes computer models for location specific layer-by-layer fabrication of three-dimensional parts (e.g., versatile design), a high degree of control over processing conditions may be achieved to enhance both the design and performance of EES components.

A composition to store electrical energy can include one or more layers of material deposited in a particulate form on a substrate, the material being at least partially consolidated by applying incident energy on the deposited material.

A composition can include a material deposited on the substrate or a previously deposited layer or material, where the material has meso-scale porosity.

In an example composition, the substrate includes an organic or inorganic material.

In an example composition, the material includes pores, and where at least a portion of the pores are in fluid communication with an environment exterior to the material.

In an example composition, the material forms a macro-scale structure without use of a chemical additive.

In an example composition, a thickness of the consolidated material is controllable.

In an example composition, a grain orientation of the consolidated material is controllable.

In an example composition, a grain size of the consolidated material is controllable.

In an example composition, the particulate form includes one or more different materials.

In an example composition, the particulate form includes an organic or inorganic material.

In an example composition, the particulate form includes a composite of one or more different ceramic materials or ceramic and metallic materials.

In an example composition, the particulate form is deposited with a chemical additive.

In an example composition, the particulate form is deposited with a chemical additive.

In an example composition, the electrical energy storage material thickness is scalable beyond 1 μm.

A device to store electrical energy can include one or more layers of material deposited in a particulate form on a substrate, the material being at least partially consolidated by applying incident energy on the deposited material.

A device of claim 15 can include a material deposited on the substrate or a previously deposited layer or material, where the material has meso-scale porosity.

In an example device, the substrate includes an organic or inorganic material.

In an example device, the material includes pores, and where at least a portion of the pores are in fluid communication with an environment exterior to the material.

In an example device, the material forms a macro-scale structure without use of a chemical additive.

In an example device, a thickness of the consolidated material is controllable.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates (a) an exemplary schematic of powder bed fusion (PBF) with inset of pulse parameters, and (b) an example of single track prepared using PBF reveals variety of achievable morphologies that can result from varying PBF process parameters. The red region of the arrow signifies higher energy density which causes the formation of cracks in this example.

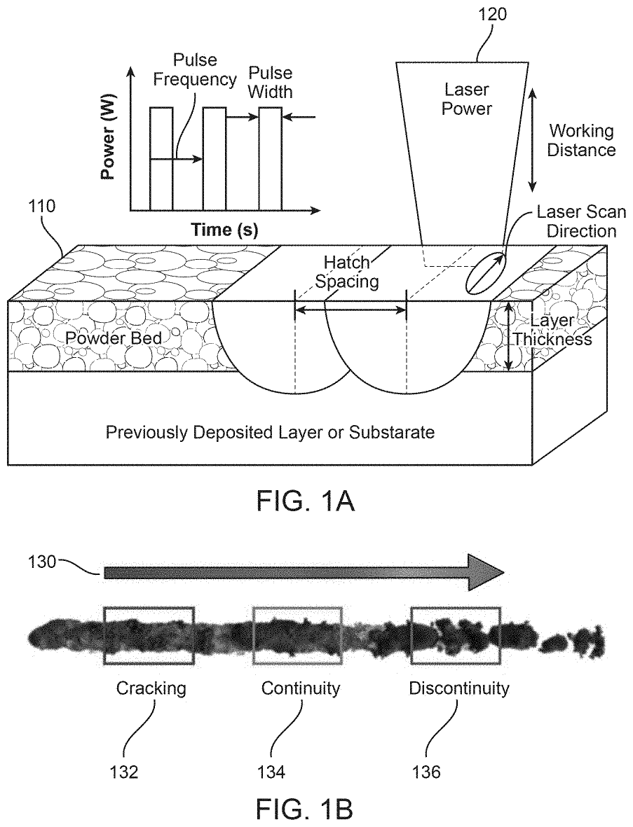

FIG. 2 illustrates an exemplary plurality of optical micrographs of the single track NCA samples (1DNCA) provided as a function of laser beam diameter and volumetric energy density.

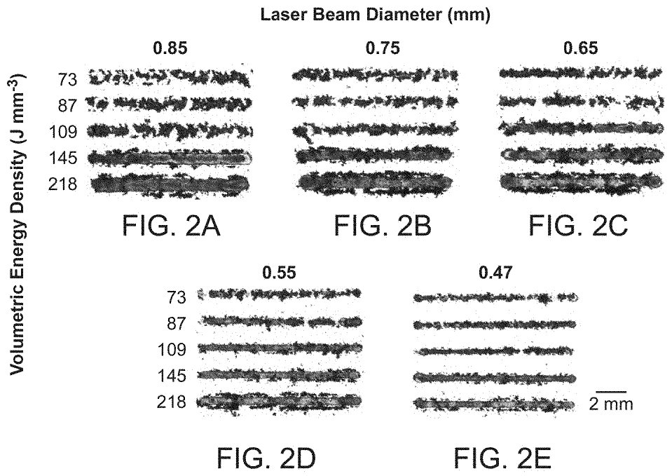

FIG. 3 illustrates an exemplary quantitative analysis of the extent of (a) discontinuity (e.g., number of segments) and (b) cracking (e.g., number of cracks), in the 1DNCA samples, is given as a function of VED. (c) The number of cracks is compared with the number of segments for five laser beam diameters.

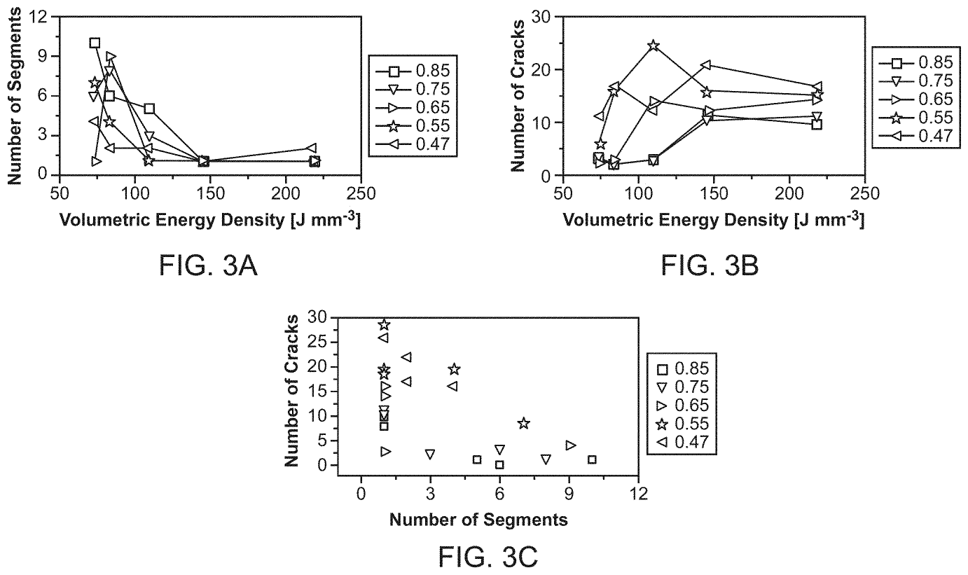

FIG. 4 illustrates an exemplary three-dimensional NCA sample (3DNCA) prepared using an exemplary HE-AM technique, PBF.

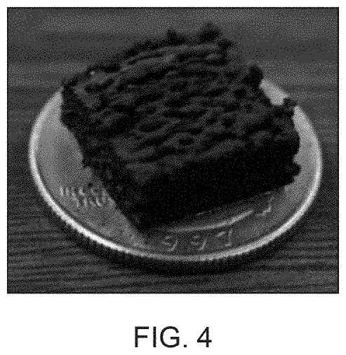

FIG. 5 illustrates an exemplary plurality of scanning electron micrographs of AR-NCA (a) primary particles and (b) secondary particles. Exemplary micrographs of the (c) bottom, (d) middle, and (e) top of the cross-sectioned 3DNCA.

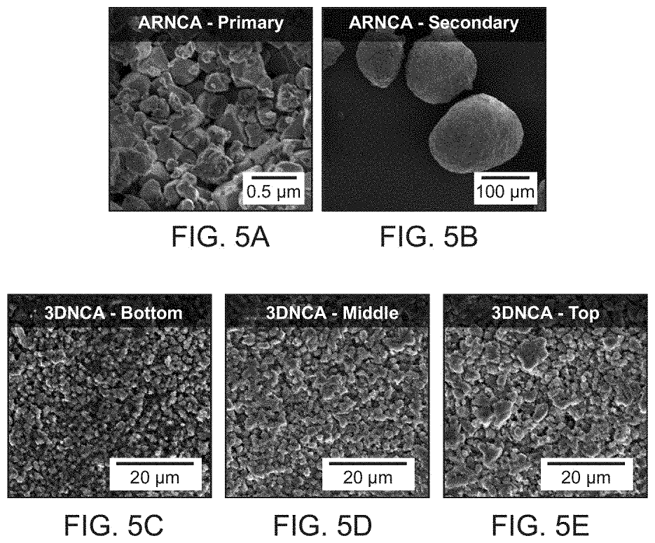

FIG. 6 illustrates exemplary energy dispersion X-ray spectroscopy data for the 3DNCA sample show a gradient in nickel (Ni), cobalt (Co), and aluminum (Al) content with build height. The chemical composition of theoretical NCA is provided for reference (dashed lines).

FIG. 7 illustrates exemplary X-ray diffraction data for AR-NCA powder compared with exemplary 3DNCA samples.

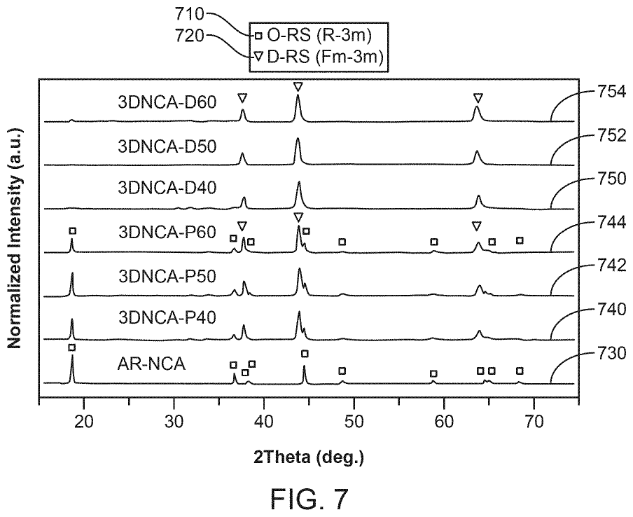

FIG. 8 illustrates exemplary electrochemical performance of exemplary AR-NCA and 3DNCA samples.

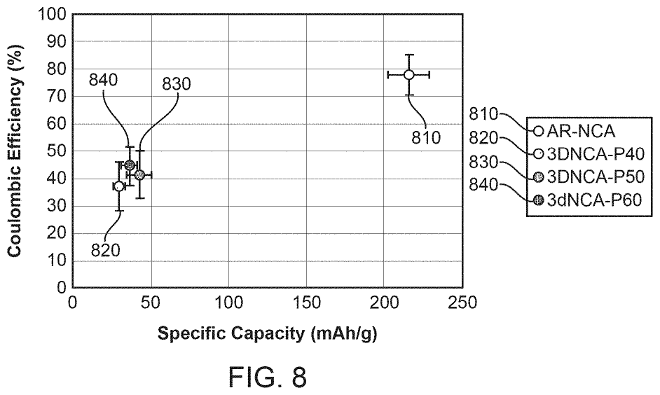

### DETAILED DESCRIPTION

Comparative EES component fabrication techniques that aim to eliminate the inclusion of chemical additives or enhance design versatility are inefficient, unsustainable, time consuming, and expensive. In some embodiments, fabrication of chemical additive-free EES components with highly versatile designs is achieved by using HE-AM to fabricate three-dimensional electrodes (e.g., cathodes) with meso-scale porosity. Exemplary embodiments are applicable to produce three-dimensional solid electrolytes to consolidate a multi-stage fabrication process of comparative batteries into a single stage.

Materials used in EES systems include chemical additives such as solvents, binders, and electronically conductive additives to aid in fabrication, durability, and energy storage and conversion capabilities. Many processing stages are involved to fabricate these EES components, namely multi-stage processing. Therefore, comparative fabrication of EES components is inefficient, time consuming, and expensive. Comparative EES components that do not include chemical additives can suffer from significant safety issues during processing. As a result, the processing environment should be regulated to reduce safety risks. Additionally, comparative fabrication methods generally lack design versatility that may improve the performance of EES systems. These factors inhibit substantial progress towards production of next generation EES systems (e.g., rechargeable batteries with high energy and power densities) for use in a wide variety of applications (e.g., large and small scale) and industries (e.g., automotive and aerospace).

Research and development efforts are pursuing alternative fabrication techniques to improve energy storage and conversion capabilities. Two main areas of focus include enhancing design versatility (e.g., through fabrication of three-dimensional EES architectures) or eliminating the inclusion of chemical additives (e.g., additive-free fabrication) to improve the performance (e.g., energy storage and conversion capabilities) of EES components (e.g., electrically conductive electrodes and ionically conductive electrolytes).

For example, production of three-dimensional electrodes for lithium ion batteries increases the surface area over which redox reactions may occur, thereby increasing the rate capabilities and power density to produce faster charging lithium ion batteries. However, battery components produced using three-dimensional printing technologies generally include chemical additives (e.g., materials other than an electrochemically active material) that increase electrode volume without increasing the amount of the electrochemically active material. This reduces the energy storage capabilities (e.g., energy density) and lifetime (e.g., due to binder degradation reactions) of the EES system. Moreover, the fabrication techniques, such as binder jetting, direct write, and laminated object manufacturing, used to improve design versatility (e.g., chemical additive-based three-dimensional printing) involve additional processing time to remove chemical additives before use of electrodes in EES systems. Expensive equipment is operated to recycle chemical additive byproducts, which increases processing time, decreases efficiency by specifying multi-stage processing, and results in longer time to market. Furthermore, chemical additives used in these fabrication methods may be toxic, resulting in additional end of life expenses for EES systems that utilize these unsustainable electrodes.

Alternatively, chemical additive-free fabrication techniques, such as pulsed laser deposition and sputtering deposition, produce thin films that are generally constrained to two-dimensions. As such, comparative chemical additive-free fabrication methods inhibit versatile design capabilities due to geometric restraints placed on the thickness and design complexity of EES components produced.

HE-AM is a rapid processing technique in which a starting material (e.g., in the form of a powder, wires, or other particulate form) is directly consolidated by an incident source of energy and deposited layer-by-layer to produce complex geometric parts. Deposition locations of the starting material are selectively assigned based on computer models. After a first layer of the material is deposited, a distance between an underlying substrate (e.g., on which additional material is deposited) and a deposition head (e.g., a location from which an incident energy and/or additional deposition material is dispensed) is adjusted and a next layer of the material is deposited. This process is repeated until an entire part is fabricated.

In some embodiments, HE-AM is used to fabricate versatile design, chemical additive-free EES components. For example, the following two types of laser-based HE-AM can be used: powder injection and powder bed fusion. For powder injection, a starting material is delivered for consolidation by an incident energy source using a set of nozzles or orifices. Powder bed fusion includes a process of directing incident energy onto a bed of powder to selectively fuse various regions. Therefore, a basic process flow is demonstrated below to cover a general approach for utilizing HE-AM to fabricate EES components.

First, an exemplary substrate (e.g., a current collector or sacrificial build plate) may be secured to a build stage (e.g., directly or onto a heating element that is included in the stage).

Next, an exemplary starting material (e.g., in the form of a powder or wires) may be applied (e.g., spread or extruded) on the substrate. Two examples are listed below for powder-based HE-AM. For powder injection, a set of powder hoppers are loaded with a powder of a first component to be deposited. A hopper with the starting material powder is selected for use during layer-by-layer deposition. Powder injection settings are selected or adjusted as appropriate. For powder bed fusion, a layer of powder of the first component is consolidated on the substrate.

Next, a build file is loaded into a computer software. Deposition parameters (e.g., an energy density, a deposition pattern, and so forth) and system parameters (e.g., a working distance, a material feed rate, and so forth) are selected or adjusted as appropriate. A deposition head starting position is adjusted to align the substrate and a deposition head. A working distance is adjusted. A process environment (e.g., argon, oxygen, nitrogen) is adjusted. The build file is then executed.

Then, a starting material for a next component to be deposited is applied on the substrate (if desired), and process stages similar to those described above are repeated, and so on until all components are deposited on the substrate.

To establish proof of concept, a lithium ion battery cathode (or a positive electrode) material, lithium nickel cobalt aluminum oxide (NCA), is processed using HE-AM powder bed fusion. NCA powder is selectively laser sintered onto a ceramic substrate using the HE-AM technique, Laser Engineered Net Shaping (LENS®) in a powder bed mode. Processing parameters are refined to allow production of porous, three-dimensional cathodes. Challenges of high temperature processing of ceramics (e.g., warping, delamination, and cracking) are mitigated by utilizing a 1070 nm fiber laser in q-switched mode and in-situ heating to modulate energy input.

HE-AM of EES components overcomes the constraints of comparative fabrication techniques by increasing geometric complexity without the inclusion of chemical additives to allow the production of high-energy and high-power density EES systems. Increased energy densities are achieved by removing the need for binders and instead loading more electrochemically active materials into the same volume as binder-based electrode composites. To accommodate the increased volume of electrochemically active material, production of three-dimensional EES components is necessary to increase the interfacial area between an electrode and an electrolyte to increase power density.

Improved capabilities of HE-AM include: tunable processing conditions even while fabrication is taking place; variable processing environment renders this technique compatible with many different types of materials; processability of a wide variety of material systems (e.g., metals, ceramics, and so forth) allows the production of various EES components (e.g., electrode and solid electrolyte) using the same machine for one-stage fabrication of EES systems; and production is readily scaled for small and large-scale applications. EES materials and components prepared with HE-AM have the following advantages.

Improved performance—Complex geometry (e.g., three-dimensional, meso-scale porosity) EES materials result in higher surface area which can increase the power of EES systems; HE-AM eliminates the inclusion of chemical additives, which can increase the volume of electrochemically active material present in EES systems for improved energy density over comparatively processed systems.

Less expensive—This technique reduces fabrication cost by allowing one-stage production of EES systems; eliminates the inclusion of solvent recapture units; and decreases the amount of factory space to prepare EES systems (e.g., smaller footprint).

Greater control over materials properties—Energy storage, conversion, and transport capabilities of EES materials are based on material properties (e.g., electrical conductivity, density of states, defect chemistry, and crystal structure) that depend on thermodynamic and kinetic processes. These processes can be influenced by incident energy sources utilized in HE-AM. Through modification of a processing environment, energy input parameters, and powder characteristics, the processing conditions used during HE-AM can be tuned to achieve suitable conditions for tailoring material properties of individual material systems to provide custom-designed energy storage and conversion capabilities. As a result, the energy storage, conversion, and transport capabilities of each material can be tuned and customized during fabrication (e.g., in-situ). This allows a single manufacturing system to produce multi-component, functional EES systems (e.g., solid-state lithium ion battery) in a single processing stage.

Shorter time to market—Eliminates the inclusion of chemical additives and additional processing stages to remove chemical additives prior to use; and consolidates multi-stage processing into a single stage.

Safer—Processing environment is readily adjusted. For example, employing inert gases (e.g., argon) when processing more reactive components can mitigate safety hazards. Furthermore, a single stage processing reduces the number of intermediate stages during which oxygen exposure and fire hazards may occur.

Greater versatility—Allows complex part design, such as three-dimensional structures or composites; increases variety of applicable material systems (e.g., metals and ceramics); increases number of EES components that may be produced using the same machine; design of material specific processing conditions during fabrication; single and multi-material deposition simultaneously or iteratively (e.g., in-situ alloying or composites); variable processing environment (e.g., gaseous argon, nitrogen, dry air); and capable of scaling production based on application. For example, small scale research and development EES components may be scaled for large scale production (e.g., mass production) and/or production of large-scale EES components (e.g., electric vehicles).

Greater structural stability—Binders used in comparative EES material composites are typically not rigid and provide constrained structural stability. The strength of EES components prepared using HE-AM can surpass binder-based electrode composites. This is beneficial for infrastructure-based applications such as the integration of EES systems into housing units.

Reduced waste material—Single-stage, chemical additive-free fabrication reduces waste material produced, compared to the use of multiple systems to remove chemical additives.

Greater sustainability—Increases the variety of materials that can be fabricated in a commercially viable manner for EES systems. This reduces the use of resources that are in finite supply and that drive up cost for EES systems, such as the use of cobalt in lithium ion batteries.

Therefore, HE-AM eliminates the inclusion of multi-stage processing and chemical additives to increase durability of EES components with enhanced design versatility. Fabrication of EES components using HE-AM can produce high-power and high-energy EES systems. HE-AM of EES components is suitable for large scale production since this technique increases process efficiency, reduces time to market, reduces the inclusion of environmentally toxic materials, reduces safety risks, and lowers the cost to store energy. Furthermore, EES components produced by HE-AM are readily tailored for use in a wide variety of applications (e.g., large and small scale) and industries (e.g., automotive and aerospace).

Example Embodiments. In some embodiments, a manufacturing method of a component of an EES system includes: (la) forming a layer on a substrate, including: depositing a starting material on the substrate; and applying incident energy on the deposited starting material to consolidate (e.g., melting or sintering) the deposited starting material and form the layer on the substrate; and (1b) optionally repeating (la) one or more times.

In some embodiments, a manufacturing method of a component of an EES system includes: (2a) forming a first layer on a substrate, including: depositing a first starting material on the substrate; and applying incident energy on the deposited first starting material to consolidate (e.g., melting or sintering) the deposited first starting material and form the first layer on the substrate; (2b) optionally repeating (2a) one or more times; (2c) forming a second layer on the first layer, including: depositing a second starting material on the first layer, wherein the second starting material has a different chemical composition than the first starting material; and applying incident energy on the deposited second starting material to consolidate the deposited second starting material and form the second layer on the first layer; and (2d) optionally repeating (2c) one or more times.

In some embodiments, a manufacturing method of a component of an EES system includes: (3a) forming a first layer on a substrate, including: depositing a first starting material on the substrate; and applying incident energy on the deposited first starting material to consolidate (e.g., melting or sintering) the deposited first starting material and form the first layer on the substrate; (3b) optionally repeating (Error! Reference source not found.) one or more times; (3c) applying incident energy on the consolidated material; (3d) optionally repeating (Error! Reference source not found.) one or more times; and (3e) optionally repeating (Error! Reference source not found. a-3d) one or more times.

In some embodiments of the manufacturing method, depositing the starting material includes depositing the starting material in a (dry or loose) particulate form. In some embodiments, the starting material in the particulate form includes particles having sizes in a range of about 0.001 μm to about 1000 μm, about 0.001 μm to about 500 μm, or about 0.001 μm to about 200 μm, about 1 μm to about 1000 μm, about 1 μm to about 500 μm, or about 1 μm to about 200 μm.

In some embodiments of the manufacturing method, a process environment (e.g., argon, oxygen, nitrogen) is adjustable.

In some embodiments of the manufacturing method, depositing the starting material includes depositing the starting material through a set of nozzles or an extrusion system.

In some embodiments of the manufacturing method, depositing the starting material includes depositing the starting material to form a powder layer on the substrate.

In some embodiments of the manufacturing method, the substrate includes an organic or inorganic material (e.g., a ceramic, a metal, a polymer or a composite thereof).

In some embodiments of the manufacturing method, forming the layer on the substrate in (1) is performed while heating the substrate, such as to a temperature in a range of about 100° C. to about 1700° C., about 200° C. to about 1700° C., or about 300° C. to about 1700° C.

In some embodiments of the manufacturing method, forming the layer on the substrate in (1) is performed without use of a chemical additive (e.g., a solvent or binder).

In some embodiments of the manufacturing method, applying the incident energy includes applying electromagnetic energy, acoustic energy, or an electron beam.

In some embodiments of the manufacturing method, applying the incident energy includes applying a laser beam. In some embodiments, applying the laser beam includes applying a pulsed laser beam. In some embodiments, applying the laser beam includes applying a q-switched continuous wave laser beam. In some embodiments, applying the laser beam includes applying an about 1070 nm fiber q-switched continuous wave laser beam. In some embodiments, applying the laser beam includes scanning a focused or defocused laser beam.

In some embodiments of the manufacturing method, the method includes adjusting (e.g., increasing) a distance between a deposition head and the substrate after consolidation of a layer of material and before repeating.

In some embodiments of the manufacturing method, the method includes adjusting a distance between an energy source head and the substrate after consolidation of a layer of material and before repeating.

In some embodiments of the manufacturing method, the component is an electrical energy storage component (e.g., electrode, solid electrolyte), and the starting material includes an electrical energy storage material, which accounts for at least about 90% by weight of a total weight of the starting material, such as at least about 93% by weight, at least about 95% by weight, at least about 98% by weight, or at least about 99% by weight.

In some embodiments of the manufacturing method, the particulate material includes one or more different materials.

In some embodiments of the manufacturing method, the particulate material is an organic or inorganic material (e.g., a ceramic, a metal, a polymer or a composite thereof).

In some embodiments of the manufacturing method, the particulate material is a composite of ceramic materials or ceramic and metallic materials.

In some embodiments of the manufacturing method, wherein the particulate material is deposited with or without a chemical additive (e.g., a solvent or binder).

In some embodiments of the manufacturing method, one or more of the particulate materials undergo chemical reaction with one or more of the particulate materials during the manufacturing method.

Additional embodiments are directed to the material of the electrical energy storage system formed by the manufacturing method of the foregoing embodiment. In some embodiments, the electrical energy storage component includes an electrode material (e.g., an electrochemically active material or an electrically conductive material) or an electrolyte material (e.g., an ionically conductive material) deposited on the substrate or previously deposited layer of material, and the electrical energy storage component has meso-scale porosity, including pores with sizes in a range of about 2 nm to about 50 nm. In some embodiments, at least some of the pores are in fluid communication with an environment exterior to the electrical energy storage component. In some embodiments, the substrate includes an organic or inorganic material (e.g., a ceramic, a metal, a polymer or a composite thereof). In some embodiments, the electrical energy storage component forms a macro-scale structure without use of a chemical additive (e.g., a solvent or binder). In some embodiments, a thickness of the consolidated electrical energy storage material is controllable. In some embodiments, a grain orientation of the consolidated electrical energy storage material is controllable. In some embodiments, a grain size of the consolidated electrical energy storage material is controllable. In some embodiments, the particulate material includes one or more different materials. In some embodiments, the particulate material is an organic or inorganic material (e.g., a ceramic, a metal, a polymer or a composite thereof). In some embodiments, the particulate material is a composite of one or more different ceramic materials or ceramic and metallic materials. In some embodiments, the particulate material is deposited with or without a chemical additive (e.g., a solvent or binder). In some embodiments, electrical energy storage material thickness is scalable beyond about 1 μm. The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

Exemplary complex microstructure and phase states in 3D lithium ion battery cathodes prepared using powder bed fusion. HE-AM may be used to prepare 3D lithium nickel cobalt aluminum oxide (NCA) cathodes without the use of chemical additives (e.g., binders or solvents). NCA may be selected as a model cathode material system for this example because thermal degradation causes changes to the crystal structure producing different phase states that are easily detected by X-ray diffraction (XRD). The change in phase state can alter electrochemical performance therefore providing insight into the electrochemical activity through facile XRD evaluation of cathodes produced using the HE-AM technique, powder bed fusion (PBF). A parametric single-track (1DNCA) evaluation may be performed to inform development of three-dimensional NCA (3DNCA) components. The 3DNCA samples exhibit high geometric complexity, open porosity, good structural stability, and partial retention of electrochemically active phase states.

Exemplary Powder Bed Fusion. During PBF, a high energy laser beam 120 selectively consolidates regions of a powder bed 110 layer-by-layer until the three-dimensional part is built (Error! Reference source not found. a). Material consolidation during HE-AM involves the absorption of laser photons within the laser-matter interaction zone. The energy absorbed then transfers to the lattice photons to produce the heat that provides sintering. Many oxide ceramics exhibit low absorption of Nd:YAG (λ: about 1.07 μm) laser energy density (e.g., the amount of optical energy delivered over a volume of material); as such, CO₂ (λ: about 10.6 μm) lasers, which can be directly absorbed, can be used. However, the large wavelength of CO₂ lasers produces larger laser beam diameter (e.g., minimum waist diameter) than Nd:YAG lasers which reduces the resolution of parts produced by PBF. The utilization of q-switched fiber lasers (λ: about 1.07 μm) overcomes the uncontrolled (e.g., avalanche) heating that arises from the low absorption of Nd:YAG lasers by some ceramics. Avalanche heating is the uncontrollable heating of a material that arises from the temperature dependence of absorption. As absorption occurs, the temperature of the material increases which increases absorption. The self-accelerating absorption produces avalanche heating that results in material degradation. Employing the q-switched fiber laser overcomes these challenges by modulating the laser input energy using pulses that can be adjusted according to the pulse frequency (Hz) and pulse width (seconds) (Error! Reference source not found. a).

Process parameters extend the versatility of PBF and influence the part quality by altering the thermal environment 130 (e.g., the cooling rate and peak temperature) that develop during processing. The process parameters dictate which structures (e.g., continuity 134) and processing defects (e.g., cracking 132, substrate drilling, discontinuity 136, balling, and lack of coupling) develop (Error! Reference source not found. b). Producing too much thermal energy causes substrate drilling, crack formation, or material vaporization; whereas, not providing enough energy results in balling, discontinuity, or no coupling between layers. Laser power and laser scan speed can be used to adjust the laser input energy. Furthermore, altering the working distance changes the laser beam diameter which influences the distribution of laser input energy and peak temperature of the material. Thermal management is desirable to mitigate crack formation due to high cooling rates that generate thermal stresses during PBF. Heating the substrate and altering the hatch rotation can reduce the thermal stresses and inhibit crack formation. Therefore, it should be possible to mitigate the challenges of laser-based ceramic processing (e.g., avalanche heating, warping, delamination, and cracking) by utilizing a q-switched fiber laser, employing in-situ substrate heating, and carefully selecting process parameters.

PBF of commercially available, as-received NCA (AR-NCA) may be conducted by outfitting the HE-AM technique, Laser Engineered Net Shaping (LENS®), with a powder bed setup. The LENS® Workstation (Optomec, Inc., Albuquerque, N. Mex., USA) is equipped with a q-switched, top hat 1 kW fiber laser (λ: about 1.07 m). Q-switching and in-situ substrate heating may be employed.

Exemplary Parametric Single-Track Evaluation. The 1DNCA samples may be prepared to establish a suitable processing window for production of high quality 3DNCA samples. The laser beam diameter and laser scan speed may be altered to vary the volumetric energy density (VED). The VED is the amount of incident laser energy introduced over a given volume of material which depends on the effective laser power P_{eff}, laser scan speed v, laser beam diameter σ, and powder bed thickness t expressed as: VED=(P_{eff}/(vσt)) [J mm⁻³]. For an exemplary pulsed laser, the effective laser power (P_{eff}) is the laser power (P) divided by the duty cycle, the product of pulse frequency (F) and pulse width (W), given by the equation: P_{eff}=P/(F*W). The 1DNCA samples may be prepared using a pulsed laser with an effective laser power of about 21 W.

Exemplary Results and Analysis. The VED and laser beam diameter alter the morphology of the 1DNCA samples (Error! Reference source not found.). The width of the 1DNCA samples scale with laser beam diameter. Specifically, the smallest laser beam diameter, a: about 0.47 mm, produces the 1DNCA samples with the smallest width (Error! Reference source not found. e).

The amount of continuity and cracking varies with VED in the 1DNCA samples (Error! Reference source not found.). Increasing the VED reduces the number of segments (Error! Reference source not found. a) while increasing the number of cracks (Error! Reference source not found. b). The number of cracks decreases as the number of segments increases (Error! Reference source not found. c). Decreasing the laser beam diameter tends to reduce the number of segments and increase the number of cracks (Error! Reference source not found. c). As such, more continuous 1DNCA, with fewer segments, exhibit more cracks than discontinuous 1DNCA. Processing parameters that produce discontinuous 1DNCA samples may be selected for the 3DNCA samples to promote the formation of open pores. The development of open pores in 3DNCA samples will increase the electrode surface area that can interact with the electrolyte and undergo redox reactions. This can increase the rate capability and power density of the lithium ion battery.

Exemplary three-dimensional NCA. The AR-NCA may be processed into three-dimensional parts (3DNCA) using PBF. Substrate pre-heating, q-switched pulsing, beam defocusing, and low input power may be used to prepare about 0.5 in×0.5 in multilayer cubes. Three samples may be prepared using different laser scan speeds, about 40 in/min, about 50 in/min, and about 60 in/min, to modulate the incident energy supplied to the material during deposition, as illustrated by way of example in Table 1. After deposition, the samples may be pulverized into powder and used in the positive electrode composites. 3DNCA cubes (about 0.4 in×0.4 in×15 layers) may be prepared using a defocused laser beam, a: about 0.65 mm, and three VED values: about 73 J mm⁻³, about 87 J mm⁻³, and about 109 J mm⁻³.

TABLE 1

| | Laser Scan Speed | | Post- |
|---|---|---|---|
| I.D. | (min⁻¹) | Processing | Processing |
| 3DNCA-D40 | 40 | Fabricated using the | None |
| 3DNCA-D50 | 50 | high energy additive | |
| 3DNCA-D60 | 60 | manufacturing (HE- | |
| 3DNCA-P40 | 40 | AM) technique, | Pulverized |
| 3DNCA-P50 | 50 | powder bed fusion. | into Powder |
| 3DNCA-P60 | 60 | | |

Exemplary Results and Analysis. The ability to deposit 15 layers of NCA using PBF and to remove the samples from the substrate demonstrates good structural stability. Open porosity is present on the surface of the 3DNCA sample (Error! Reference source not found.). Therefore, the process parameters selected in the 1DNCA evaluation successfully produced open porosity in the 3DNCA samples. HE-AM processing of NCA yields distinct differences in microstructure, chemical composition, and crystal structure compared to AR-NCA.

Exemplary Microstructure. The scanning electron micrographs of AR-NCA powder reveal that the non-spherical secondary particles (Error! Reference source not found. b) are comprised of faceted, cubic primary particles (Error! Reference source not found. a). The as-deposited 3DNCA samples exhibits larger grains (Error! Reference source not found. c-e) than AR-NCA (Error! Reference source not found. a) with an increase in grain size from the bottom (Error! Reference source not found. c) to the top (Error! Reference source not found. e) of the sample. A grain size gradient can occur in HE-AM due to the accumulation of thermal energy during the layer-by-layer addition of material.

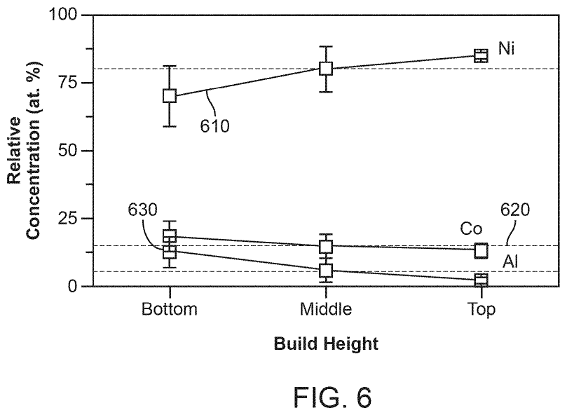

Exemplary Chemical Composition. The average relative metal content (Ni, Co, Al) is comparable to theoretical NCA (Error! Reference source not found.). The average metal content for the 3DNCA sample is about 79 at. % Ni, about 16 at. % Co, and about 5 at. % Al; whereas, theoretical NCA is comprised of about 80 at. % Ni, about 15 at. % Co, and about 5 at. % Al. Local composition varies with build height. FIG. 6 illustrates, by way of example, a graph of build height compared to relative concentration (at. %) for exemplary nickel (Ni) structure 610, exemplary cobalt (Co) structure 620, and exemplary aluminum (Al) structure 630. For instance, the concentration of nickel 610 increases with build height, while cobalt 620 and aluminum 630 decrease (Error! Reference source not found.). This may result from the evolution of lithium and oxygen during HE-AM which produces higher defect concentrations within regions of higher temperatures. The laser spot produces the highest temperatures which will in turn generate highly localized heating cycles with the addition of each layer of material. Nickel may preferentially segregate to the laser spot, where defect generation likely occurs, since nickel has a higher diffusion rate than cobalt and aluminum in NiO, Co₃O₄, and Al₂O₃, respectively. High nickel content can promote phase transformations at lower temperatures by degrading the thermal stability of NCA.

Exemplary Crystal Structure. X-ray diffraction experiments show exemplary variations in the crystal structures present in AR-NCA and the 3DNCA samples, as illustrated by way of example in Error! Reference source not found. The exemplary AR-NCA powder has the layered, ordered rock salt (O-RS) structure 710 of many intercalation type lithium ion battery cathodes 730. The 3DNCA samples exhibit a single disordered rock salt (D-RS) phase 720 at the top of the as-deposited sample 750, 52 and 754; whereas, a dual phase state, ordered and disordered rock salt, is present throughout the bulk of the 3DNCA samples 740, 742 and 744. The change in chemical composition with build height may contribute to the variation in phase state throughout the 3DNCA samples. High nickel content and low lithium content can degrade the thermal stability of NCA. As such, phase transformations from the ordered 710 to the disordered 720 rock salt crystal structure are more likely at the top of the 3DNCA sample where nickel content is highest. While the retention of the O-RS phase 710 in the 3DNCA samples is promising for electrochemical performance, the D-RS 720 can reduce the capacity and rate capability of the cathode.

Exemplary Electrochemical Testing of 3DNCA. Pulverized 3DNCA-P40, 3DNCA-P50, and 3DNCA-P60 and AR-NCA may be incorporated in positive electrode composites for galvanostatic cyclic voltammetry to test the performance in a coin cell battery. The positive electrode composite utilizes a combination of about 85 wt. % NCA powder with about 15 wt. % SuperP® conductive carbon black and about 5 wt. % Polyvinylidene fluoride (PVDF). The composite may then be spread onto an aluminum foil current collector using the Dr. Blade 300 μm setting. The coin cell utilizes a Celgard separator, Li metal anode, and about 1.0 M of LiPF₆ in EC:DEC:DMC (about 1:1:1) electrolyte.

Exemplary Results and Analysis. The average first charge specific capacity is plotted against the coulombic efficiency for AR-NCA 810, 3DNCA-P40 820, 3DNCA-P50 830, and 3DNCA-P60 840 (Error! Reference source not found.). The specific capacity is the amount of charge stored by the cathode per gram of material. The coulombic efficiency is the change in specific capacity for the first charge/discharge cycle.

Exemplary 3DNCA samples 820, 830 and 840 prepared using the PBF exhibit less than about 50 mAh/g and about 50% coulombic efficiency. Although AR-NCA 810 offers higher specific capacity, about 215.6 mAh/g, and coulombic efficiency, about 77.8%, 3DNCA-P40 820, 3DNCA-P50 830, and 3DNCA-P60 840 provide electrochemical activity. Further, in this example all samples may be pulverized into powder and assembled as a cathode composite. As such, additional optimization can be performed to improve electrochemical activity of cathodes prepared using high-energy additive manufacturing (HE-AM), and further testing of these samples as thick films can elucidate the influence of the three-dimensional structures.

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to +10% of that numerical value, such as less than or equal to +5%, less than or equal to +4%, less than or equal to +3%, less than or equal to +2%, less than or equal to +1%, less than or equal to +0.5%, less than or equal to ±0.1%, or less than or equal to ±0.05%. For example, a first numerical value can be “substantially” or “about” the same as or equal to a second numerical value if the first numerical value is within a range of variation of less than or equal to ±10% of the second numerical value, such as less than or equal to ±5%, less than or equal to ±4%, less than or equal to ±3%, less than or equal to +2%, less than or equal to ±1%, less than or equal to ±0.5%, less than or equal to ±0.1%, or less than or equal to ±0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claim(s). In addition, many modifications may be made to adapt a particular situation, material, composition of matter, method, operation or operations, to the objective, spirit and scope of the disclosure. All such modifications are intended to be within the scope of the claim(s) appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A composition to store electrical energy, the composition comprising:
one or more layers of material deposited in a particulate form on a substrate, the material being at least partially consolidated by applying incident energy on the deposited material.

2. The composition of claim 1, further comprising:
a material deposited on the substrate or a previously deposited layer or material,
wherein the material has meso-scale porosity.

3. The composition of claim 1, wherein the substrate includes an organic or inorganic material.

4. The composition of claim 1, wherein the material includes pores, and wherein at least a portion of the pores are in fluid communication with an environment exterior to the material.

5. The composition of claim 1, wherein the material forms a macro-scale structure without use of a chemical additive.

6. The composition of claim 1, wherein a thickness of the consolidated material is controllable.

7. The composition of claim 1, wherein a grain orientation of the consolidated material is controllable.

8. The composition of claim 1, wherein a grain size of the consolidated material is controllable.

9. The composition of claim 1, wherein the particulate form includes one or more different materials.

10. The composition of claim 1, wherein the particulate form includes an organic or inorganic material.

11. The composition of claim 1, wherein the particulate form includes a composite of one or more different ceramic materials or ceramic and metallic materials.

12. The composition of claim 1, wherein the particulate form is deposited with a chemical additive.

13. The composition of claim 1, wherein the particulate form is deposited with a chemical additive.

14. The composition of claim 1, wherein the electrical energy storage material thickness is scalable beyond 1 μm.

15. A device to store electrical energy, the device comprising:
one or more layers of material deposited in a particulate form on a substrate, the material being at least partially consolidated by applying incident energy on the deposited material.

16. The device of claim 15, further comprising:
a material deposited on the substrate or a previously deposited layer or material,
wherein the material has meso-scale porosity.

17. The device of claim 15, wherein the substrate includes an organic or inorganic material.

18. The device of claim 15, wherein the material includes pores, and wherein at least a portion of the pores are in fluid communication with an environment exterior to the material.

19. The device of claim 15, wherein the material forms a macro-scale structure without use of a chemical additive.

20. The device of claim 15, wherein a thickness of the consolidated material is controllable.
